(19) United States
(12) Patent Application Publication
(10) Pub. No.: US 2012/0154247 A1
(43) Pub. Date: Jun. 21, 2012

(54) MULTIBAND ANTENNA DEVICE AND PORTABLE RADIO COMMUNICATION DEVICE COMPRISING SUCH AN ANTENNA DEVICE

(75) Inventors: Christian Braun, Stockholm (SE); Per Erlandsson, Stockholm (SE); Stefan Irmscher, Taby (SE)

(73) Assignee: LAIRD TECHNOLOGIES AB, Kista (SE)

(21) Appl. No.: 13/274,017

(22) Filed: Oct. 14, 2011

Related U.S. Application Data
(63) Continuation of application No. PCT/SE2009/050384, filed on Apr. 15, 2009.

(51) Int. Cl. H01Q 3/24

(52) U.S. Cl. 343/876

(57) ABSTRACT

An antenna device for a portable radio communication device comprises a first electrically conductive radiating element including a basic resonance defining section having a first end, a length varying section connected between a feed point of the radiating element and the first end of the basic resonance defining section. The length varying section includes a set of parallel conductive paths and a first switching element selectively supplying radio signals between the feed point and the basic resonance defining section via one of the paths in the set. Each path influences the resonance of the radiating element in a separate way and at least one path includes a reactive element for adjusting the resonance of the first radiating element.

### CROSS REFERENCE TO RELATED APPLICATION

This application is continuation of PCT International Application No. PCT/SE2009/050384 filed Apr. 15, 2009, published as WO 2010/120218 on Oct. 21, 2010. The entire disclosure of the above application is incorporated herein by reference.

### FIELD

The present disclosure relates generally to antenna devices and more particularly to an antenna device for a portable radio communication device operable in at least a first and a second set of frequency bands. The present disclosure also relates to a portable radio communication device comprising such an antenna device.

### BACKGROUND

The statements in this section merely provide background information related to the present disclosure and may not constitute prior art.

Internal antennas have been used for some time in portable radio communication devices. There are a number of advantages associated with the use of internal antennas, of which can be mentioned that they are small and light, making them suitable for applications wherein size and weight are of importance, such as in mobile phones.

In such portable radio communication devices, there are more and more different radio communication standards. These then typically require different frequency bands. One standard may here also use more than one frequency band.

It is then customary to use a radiating element in the antenna device that resonates in a frequency band.

It is then often desired that one antenna device is to be used for communication in many such different frequency bands. The radiating element is then to resonate in more than one frequency band.

This is hard to accomplish in a small portable radio communication device.

One known way to provide a quad-band antenna is described in EP 1858115, where two conductors of different lengths are used together with two different sized radiating elements in order to obtain quad band operation.

A problem in prior art antenna devices is thus to provide a small sized multi-band antenna covering more than one set of frequency bands while retaining good performance.

### SUMMARY

An antenna device for a portable radio communication device comprises a first electrically conductive radiating element including a basic resonance defining section having a first end, a length varying section connected between a feed point of the radiating element and the first end of the basic resonance defining section. The length varying section includes a set of parallel conductive paths and a first switching element selectively supplying radio signals between the feed point and the basic resonance defining section via one of the paths in the set. Each path influences the resonance of the radiating element in a separate way and at least one path includes a reactive element for adjusting the resonance of the first radiating element.

Further aspects and features of the present disclosure will become apparent from the detailed description provided hereinafter. In addition, any one or more aspects of the present disclosure may be implemented individually or in any combination with any one or more of the other aspects of the present disclosure. It should be understood that the detailed description and specific examples, while indicating exemplary embodiments of the present disclosure, are intended for purposes of illustration only and are not intended to limit the scope of the present disclosure.

### DRAWINGS

The drawings described herein are for illustration purposes only and are not intended to limit the scope of the present disclosure in any way.

FIG. 1 is an overall view of a portable radio communication device in which an antenna device may be provided;

FIG. 2 shows a schematic diagram of a first radiating element used in an antenna device according to a first embodiment;

FIG. 3 shows an antenna device according to the first embodiment where the first radiating element has a first type of switching element and conductive path combination;

FIG. 4 shows an antenna return loss diagram for the antenna device according to the first embodiment;

FIG. 5 shows a second type of switching element and conductive path combination that can be used in various embodiments;

FIG. 6 shows a comparison between switch losses of the antenna device of the first embodiment having the first type of switching element and conductive path combination and an antenna device according to a second embodiment where the second type of switching element and conductive path combination is used;

FIG. 7 shows a schematic diagram of a third embodiment of an antenna device using the first type of switching element and conductor combination, but including a second radiating element in series with the first radiating element via a first type of selective connection element;

FIG. 8 shows an antenna return loss diagram for the antenna device according to the third embodiment; and

FIG. 9 shows a second type of selective connection element that can be used between the first and the second radiating elements in the antenna device according to the third embodiment.

### DETAILED DESCRIPTION

The following description is merely exemplary in nature and is in no way intended to limit the present disclosure, application, or uses.

According to various aspects of the present disclosure, there is provided an antenna device that covers more than one set of frequency bands while still keeping the overall size of the antenna device small. This is based on the inventors' realization that multi-band coverage ability can be provided in a small sized antenna device operable in dual bands through modifying this antenna device by providing a length varying section with more than one conductive parallel path, where at least one path includes a reactive element and each path influences the resonance of the antenna device in a separate way. According to a first aspect of the present disclosure there is provided an antenna device as defined in claim 1. According to a second aspect of the present disclosure there is provided portable radio communication device as defined in claim 18. Further preferred embodiments are defined in the dependent claims.

Exemplary embodiments provides an antenna device and a portable radio communication device wherein the problem of providing an antenna device that covers more than one set of frequency bands while still keeping the overall size of the antenna device small is solved through the antenna device having a first electrically conductive radiating element that includes a basic resonance defining section and a length varying section. The basic resonance defining section has a first and a second end and an electrical length selected to contribute to the total electrical length of the radiating element for obtaining resonance at least in a first set of frequency bands. The length varying section is connected between a feed point of the radiating element and the first end of the basic resonance defining section and includes a set of parallel conductive paths between the feed point and the basic resonance defining section. The set of paths includes at least a first and a second conductive path and each path influences the resonance of the electrically conductive radiating element in a separate way. There is also a contact area for a first switching element enabling the switching element to connect the antenna feed point to the conductive paths in order to selectively supply radio signals between the feed point and the basic resonance defining section via one of the paths in the set of conductive paths. At least one conductive path is arranged to include a reactive element for adjusting the resonance of the first radiating element.

FIG. 1 shows the outlines of a portable radio communication device 1, such as a mobile phone. An antenna carrier 3 is arranged at the top of the communication device, adjacent to a printed circuit board (PCB) 2. This antenna carrier 3 may be provided in the form of a flex film or a middle deck of the portable radio communication device. Between the antenna carrier 3 and the PCB 2 there is at least one electrical connection. On the PCB 2 there are provided RF feeding and grounding devices (not shown) that are connected to the antenna device. In different variations, the antenna device may be wholly provided on the carrier 3, wholly provided on the PCB 2 or parts of it may be provided on the PCB 2 and parts on the antenna carrier 3. When the antenna device is wholly provided on the PCB, there would normally not be any antenna carrier. When at least some parts of the antenna device are provided on the antenna carrier 3, the number of connections provided between PCB 2 and antenna carrier 3 depends on type of antenna and the distribution of its parts between carrier 3 and PCB 2.

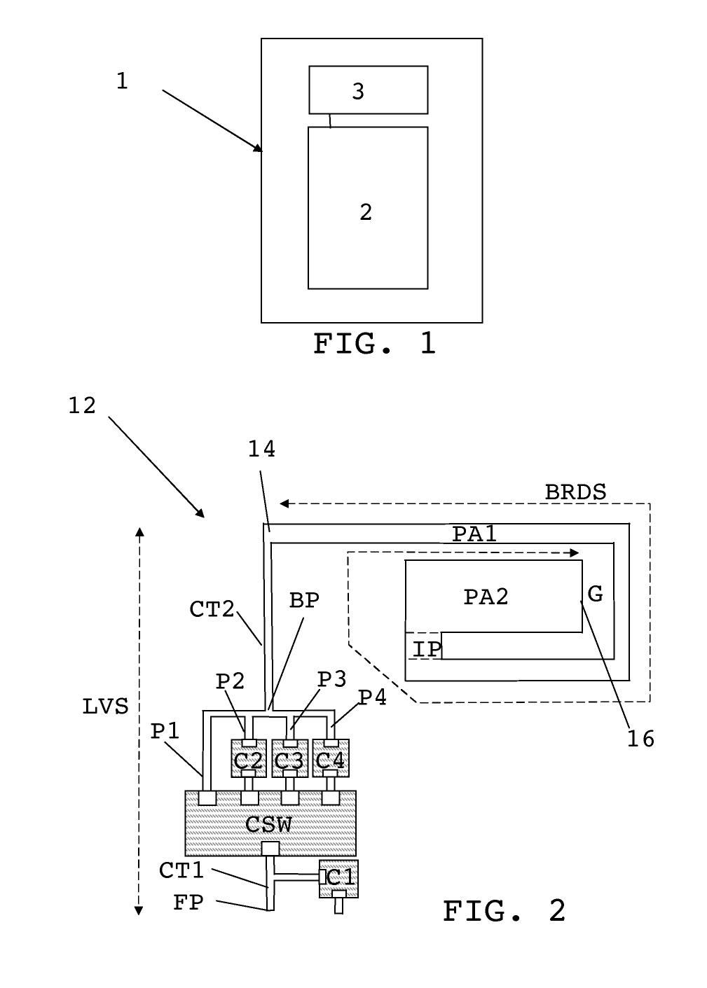

In FIG. 2, there is shown a general outline of a conductive material structure used for providing a first electrically conducting radiating element 12. Such a conductive material structure may make up parts or the whole antenna device according to the present disclosure. The whole or parts of the structure may be provided through conductor traces made of an electrically conductive material, such as copper. This material may furthermore be provided on a flex film, which may in turn be bent or folded in order to fit within a portable radio communication device.

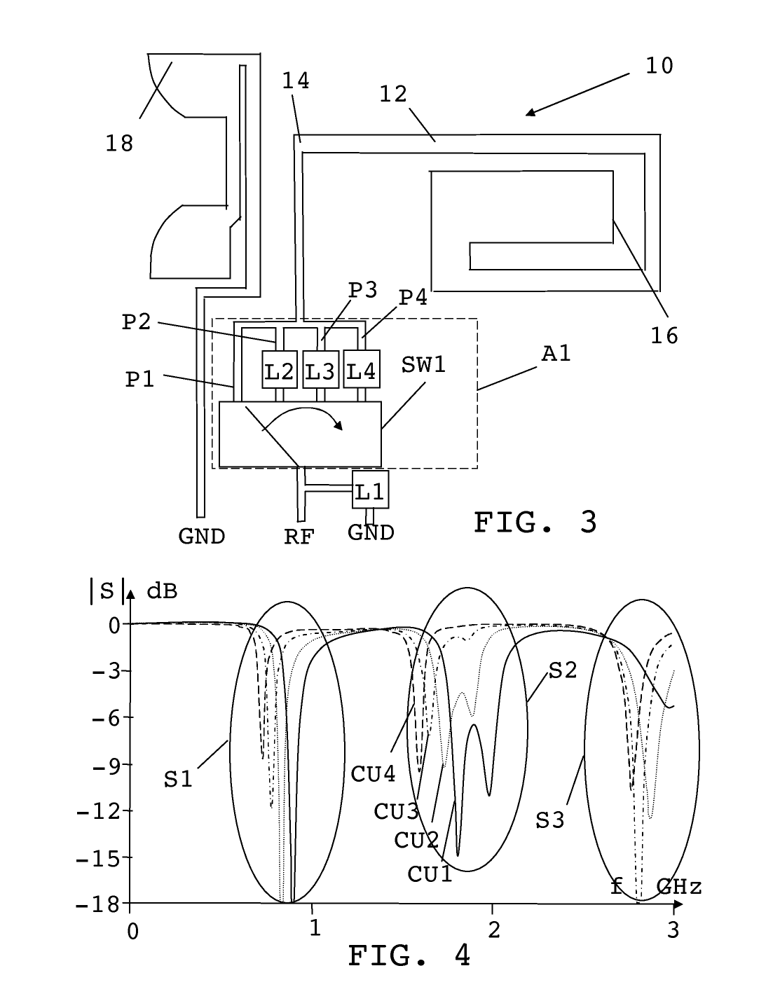

An antenna device according to a first embodiment includes the radiating element of FIG. 2 is schematically shown in FIG. 3. The antenna device according to the first embodiment will now be described with reference being made to FIGS. 2 and 3.

The antenna device 10 is operable in at least a first and a second set of frequency bands, where the first set includes at least two frequency bands and the second set includes at least one frequency band. In order to provide such operation, the antenna device 10 includes a set of sections of electrically conductive material joined to each other for forming a first electrically conductive radiating element 12. In embodiments disclosed here, there is a basic resonance defining section BRDS and a length varying section LVS.

The antenna device 12 is in this first embodiment furthermore an IFA antenna and therefore the first electrically conducting radiating element 12 has two legs, where one leg is provided with a feed point FP for receiving radio signals RF, for instance from RF circuitry in the portable radio communication device 1 shown in FIG. 1. The other leg is to be connected to ground GND.

The feed point FP is provided at one end of the first leg or length varying section LVS. In this first embodiment the leg or length varying section LVS is thus made up of a number of conductor traces. There is here a first straight conductor trace CT1 leading from the feed point PF to a switching element contact area CSW. This switching element contact area CSW is an area provided for a first switching element SW1 having four switch positions. In this first embodiment the switching element SW1 may be a single pole, four-throw switching element (SP4T), for instance a GaAs FET device that is reflective in the off state. In the switching element contact area CSW there is in this first embodiment therefore provided five contact pads. This means that the switching element contact area CSW has contact pads to which contacting elements, like contacting pins of the first switching element SW1, may be soldered. Thereby the switching element contact area CSW enables the first switching element SW1 to selectively supply radio signals between the feed point FP and the basic resonance defining section BRDS via one of the paths in the set of conductive paths. FIG. 2 shows the structure without first switching element, while FIG. 3 shows the structure with the first switching element SW1 connected to the switching element contact area CSW. There is here a first contact pad connecting the switching element with the feed point FP via the first conductor trace CT1. There is also a second, third, fourth and fifth contact pad, each being arranged to connect a switch position of the first switching element SW1 with a corresponding conductive path P1, P2, P3 and P4 in a set of conductive paths, which paths are also provided as conductive traces.

The number of paths may vary. There may be as few as two paths. The number of paths provided may be denoted n, which in the embodiments described here are four. According to the principles of the first embodiment all n paths are connected between the contact area CSW for the first switching element SW1 and the first end 14 of the basic resonance defining section BRDS.

Also the second ground leg or ground connection leads to the first switching element via a matching element contact area C1 for a matching element. The matching element is in this first embodiment a matching component that is to be placed in this matching element contact area C1 and connected to contact pads of this matching element contact area. The matching element is here a matching inductor L1. A connection to a matching inductor L1 is thus provided via the length varying section and here between the antenna feed point FP and the first switching element and more particularly via the first conductive trace CT1. The matching element may match the feed point FP to 50Ω.

The first switching element SW1 is, as was mentioned earlier, switchable between four switching positions leading to different conductive paths in the set of conductive paths. A first switching position connects the feed point FP with a first conductive path P1, a second position connects the feed point FP with a second conductive path P2, a third position connects the feed point FP with a third conductive path P3 and a fourth position connects the feed point PF with a fourth conductive path P4. All paths are thereafter connected to a first end 14 of the first radiating element 12. The first path is here only made up of a conductor, while the other paths are each arranged to include a reactive element. Here the second conductive path P2 includes a reactive element contact area C2 in a conductor and having contact pads for a reactive element, here a second inductor L2, the third conductive path P3 includes a reactive element contact area C3 in a conductor and having contact pads for a further reactive element, here a third inductor L3 while the fourth conductive path includes a reactive element contact area C4 in a conductor and having contact pads for another reactive element in the form of a fourth inductor L4. Each reactive element contact area thus includes two contact pads, one connecting a reactive element with the first switching element and the other connecting the reactive element with the basic resonance defining section BRDS. The reactive elements have different values, where the reactive element of the fourth path P4 has the highest value, here as an example 15 nH, the reactive element of the third path P3 has a lower value, here as an example 10 nH, and the reactive element of the second path P2 has an even lower value, here as an example 5 nH. All paths are then connected to a common branching point BP. They thus also meet at this point. The different paths P1, P2, P3, P4 organized in this way provide a first switching element and path combination A1 together with the first switching element SW1.

In this first embodiment the matching and reactive elements are provided as components. These can be lumped components attached to the antenna structure of the antenna device, for instance through soldering to the corresponding contact pads.

From the branching point BP a second straight conductor trace CT2 leads to a first end 14 of a basic resonance defining section BRDS. This first end 14 of the basic resonance defining section BRDS also marks the end of the length varying section LVS. This means that the paths P1, P2, P3 and P4 stretch in parallel between the feed point FP and the basic resonance defining section BRDS. The basic resonance defining section BRDS here basically stretches out orthogonally from the length varying section LVS and then particularly from the second conductive trace CT2 of the length varying section LVS. The basic resonance defining section BRDS has received its name because the dimensioning of this section has a major influence on the resonance frequencies in all sets of frequency bands to be covered by the antenna device and then the most influential for resonance in at least one of the sets of frequency bands. In this first embodiment it is the most influential part of the antenna device for the provision of all frequency bands to be covered.

The basic resonance defining section BRDS of the radiating element 12 includes from the first end 14 a first elongated part PA1 that is joined to a second elongated part PA2 via an interconnecting part IP. At the end of this second elongated part PA2 the second end 16 of the basic resonance defining section BRDS is provided. In FIG. 2 the borders between the various parts of the basic resonance defining section BRDS are indicated with dashed lines in the conductive material structure. The joined parts and sections may furthermore be provided in one piece. There are in this case no joints between them.

The second part PA2 is electrically connected in series with the first part PA1. It is at the same time provided side by side with the first part PA1. This means that the first part PA1 has a certain extension and that the second part PA2 then stretches back along the first part PA1 displaced a distance from it, where this displacement provides a gap G between the first and second parts PA1 and PA2.

In more detail the first part PA1 in the first embodiment includes a first piece that is straight and preferably has a bar shape. This first piece of the first part PA1 is thus at a first end of this first piece joined to the length varying section LVS and may furthermore be provided at right angles to the longitudinal direction of this length varying section LVS and then furthermore at right angles to the second conductive trace CT2. In the first embodiment the first piece of the first part PA1 has a second opposite end where it is joined to a first end of a second straight bar-shaped piece. This second piece is perpendicular to the first piece and stretches from the first piece in parallel with the second conductive trace CT2 of the length varying section LVS. Also the second piece has a second opposite end, which is joined to a first end of a third straight bar-shaped piece stretching back in a direction towards the second conductive trace CT2 of the length varying section LVS and in parallel with the first piece.

The third straight bar shaped piece of the first part PA1 has a second opposite end that is joined to an interconnecting part IP. This interconnecting part IP is here provided as a rectangle provided at a side of the third piece that faces the first piece. This interconnecting part IP then joins the second part PA2. The second part PA2 in this first embodiment has a rectangular shape and is placed with a first long side provided in parallel with and distanced a first distance from the first piece of the first part PA1, a first short side provided in parallel with and distanced a second distance from the second piece of the first part and a second long side provided in parallel with and distanced a third distance from the third piece of the first part PA1. The first short side of the second part PA2 here makes up the second end 16 of the basic resonance defining section BRDS. The third distance is determined by the size of a side of the interconnecting part IP that is parallel with the second conductive trace CT2, the first distance is determined by the size of the same side of interconnecting part IP and the size of the first short side of the second part PA2, while the second distance is determined by the difference in size between the second long side of the second part and the length of the third piece of the first part.

The first part PA1 here has an inner side that is made up of each side of the three pieces of the first part PA1 facing the second part PA2, while the second part PA2 has an inner side made up of the first long rectangle side facing the first piece of the first part PA1, the first short side facing the second piece of the first part PA1 and the second long side facing the third piece of the first part PA1. Thus the inner side of the second part PA2 faces, is displaced a distance from and stretches along the inner side of the first part PA1, thereby forming the gap G between the first and second parts. It should here be realized that the shapes of the three parts are exemplifying and can be varied in many ways. This is especially the case for the interconnecting and the second parts IP and PA2.

Finally the antenna device according to the first embodiment includes a parasitic element 18 that is in one end connected to ground GND. This parasitic element 18 is a conductive elongated parasitic element provided close to the length varying section LVS of the radiating element and more particularly generally provided along this length varying section. Thus it is also provided close to the first end 14 of the basic resonance defining section BRDS of the radiating element 12. The parasitic element 18 is thus not galvanically coupled to the length varying section LVS. However, there is an electromagnetic coupling between the parasitic element and the length varying section. The tuning of the length varying section influences this electromagnetic coupling.

The whole antenna device may be provided on the antenna carrier in FIG. 1. It is also possible that the first conductive trace CT1, the first switching element SW1, the matching element L1 and the connection to it are provided on the PCB. It is further possible that the various conducting paths are provided on the PCB, in which case the second conductive trace CT2 is used for interconnecting the separated parts of the antenna device. In these variations of the antenna device, the parasitic element 18 and the basic resonance defining section BRDS should normally be provided on the antenna carrier. However, the whole antenna device may alternatively, as has been mentioned earlier, be wholly provided on the PCB.

All the parallel conductive paths P1, P2, P3 and P4 of the length varying section LVS influence the resonance of the first electrically conductive element 12 in separate ways. The length of the first path P1 of the length varying section LVS is selected for making the radiating element 12 resonate with fundamental resonance at a first basic frequency in a first set of frequency bands. This is done through providing a resonating element length made up of the length of the length varying section when the first path P1 is conducting and the total length of the basic resonance defining section BRDS. The length of the length varying section LVS is in this case made up of the length of the first path P1 plus the lengths of the first and the second conductive traces CT1 and CT2, while the length of the basic resonance defining section BRDS is made up of the lengths of the first part PA1, the interconnecting part IP and the second part PA2. These together form a total length for which the radiating element resonates in a first frequency in the first set of frequency bands, which total length typically corresponds to a quarter of a wavelength of this frequency. The other paths P2, P3 and P4 have the effect of shifting or adjusting the resonance through the use of the respective reactive elements in the corresponding paths. This means that the second path P2 provides resonance at a second frequency in the first band, the third path P3 provides resonance at a third frequency and the fourth path P4 provides resonance at a fourth frequency. Since the reactive elements are inductive, this shifting is furthermore made downwards in frequency based on the value of the element in question, where a higher value provides a lower frequency.

It should here be realised that as long as the required electrical length of the radiating element is obtained, the shape of the first, second and interconnecting parts can be varied in a multitude of ways. They do for instance not have to be straight. It is for instance possible that one or more of the parts have meandering shape. The number of parts in the gap can vary from one to several. Each such part may furthermore have varying shape and varying displacement of the second part from the first part. The width of a part can thus be variable.

The dimensions of the gap G between the first and the second parts PA1 and PA2 of the basic resonance defining section BRDS are on the other hand selected to provide resonance of the radiating element in a second set of frequency bands. This means that the length and the width of the gap G are selected to provide resonance of the radiating element in the second set of frequency bands. Also this resonance is shifted or adjusted depending on which path interconnects the feed point FP with the basic resonance defining section BRDS.

The parasitic element has the function of providing further resonances in the set of frequency bands.

The dimensions of the first radiating element that provides fundamental resonance in the first set of frequencies furthermore also provides harmonic resonance in a third set of frequency bands. This means that the second set covers frequencies that are higher than the frequencies in the first set, and the third set covers frequencies that are higher than the frequencies in the second set.

The broadband properties of the antenna device according to the first embodiment can be seen in FIG. 4, which shows the antenna return loss of the antenna device in dependence of frequency. The return loss |S| is here shown in dB while the frequency is shown in GHz. In the figure there are four curves, one for each position of the first switching element. There is thus a first (solid) curve CU1, representing the case when the first path interconnects the feed point with the basic resonance defining section of the first radiating element, a second (dotted) curve CU2 representing the case when the second path interconnects the feed point with the basic resonance defining section of the first radiating element, a third (dash-dotted) curve CU3 representing the case when the third path interconnects the feed point with the basic resonance defining section of the first radiating element and a fourth (dashed) curve CU4 representing the case when the fourth path interconnects the feed point with the basic resonance defining section of the first radiating element.

As can be seen each curve has three regions or sets of frequency bands S1, S2 and S3 where performance is good. A lower frequency region with frequencies below 1 Ghz covering the first set S1 of frequency bands, a mid-region with frequencies closer to 2 GHz covering the second set S2 of frequency bands and a high frequency region closer to 3 GHz covering the third set S3 of frequency bands. The low frequency region S1 here corresponds to fundamental resonances provided through the length of the first radiating element, the mid region S2 to resonances provided by the band gap and enhanced by the parasitic element and the third region S3 by harmonics of the resonance provided through the length of the first radiating element.

As can be seen the antenna device provides resonance in a first frequency band of the first set S1 when the first conductive path is conducting, provides resonance in a second frequency band of the first set S1 when the second conductive path is conducting, provides resonance in a third frequency band of the first set S1 when the third conductive path is conducting and provides resonance in a fourth frequency band of the first set S1 when the fourth conductive path is conducting. Resonance is here deemed to occur when the return loss is below −6 dB.

In the same manner the antenna device provides resonance in a first frequency band of the second set S2 when the first conductive path is conducting, provides resonance in a second frequency band of the second set S2 when the second conductive path is conducting, provides resonance in a third frequency band of the second set S2 when the third conductive path is conducting and provides resonance in a fourth frequency band of the second set S2 when the fourth conductive path is conducting. Here the first and also the second band of this second set S2 both have significant further resonances because of the parasitic element. The parasitic element thus provides more resonances in the second set covered by the radiating element through the use of the gap.

Finally the antenna device provides resonance in a first frequency band of the third set S3 when the second conductive path is conducting, provides resonance in a second frequency band of the third set when the third conductive path is conducting and provides resonance in a third frequency band of the third set S3 when the fourth conductive path is conducting. Here there is a resonance when the first path is conducting. However it is weak and much higher than −6 dB. Thus the first curve CU1 has an insignificant resonance in the third set S3. This first path is therefore in this first embodiment thus not used in this third set S3.

Here the first curve CU1 is related to the highest frequencies in a set, the second curve CU2 to lower frequencies, the third curve CU3 to even lower frequencies and the fourth curve CU4 to the lowest frequency in the set. This means that in this embodiment the reactive elements of the paths function to lower the frequency covered. This also means that the fourth path has a higher reactance than third path, which in turn has a higher reactance than the second path.

As can be seen from FIG. 4 through providing different paths that can be selectively connected to the first radiating element a broadening of the coverage in all the sets of frequency bands is provided for a basic dual band structure provided by the basic resonance defining section. Here all or three paths may be selected when frequencies in the first set of bands are to be used, the first, second and third paths or only the first path may be selected when frequencies in the second set of bands are to be used, and the second, third and fourth paths or only one of the second third or fourth paths be selected when frequencies in the third set of bands are to be used.

The first set of frequency bands may typically be frequency bands in the region between 700-1000 MHz and thus cover such bands as LTE, GSM 850 and GSM 900, the second set may cover bands between 1700-2200 MHZ like DCS and PCS bands as well as UMTS bands, while the third set of frequency bands may cover up to 2.6 GHz in order to enable coverage of Bluetooth communication and a further LTE band.

In this way it is possible to obtain an antenna device that can be used in several frequency bands including the low LTE frequency band while still being small in size and using a limited number of elements contributing to radiation.

Through connecting the matching inductor to the input of the first switching element a further advantage is here obtained. The frequency can be shifted without significantly changing the input impedance, which would vary in case the matching inductor would be connected directly to the first radiating element instead. With this placing of the matching inductor a large tuning range can be obtained with a limited impact on the size of the antenna device.

The first embodiment may be varied in a number of ways. The antenna device may be a patch antenna, like a PIFA antenna or a loop antenna. A loop antenna may for instance be provided through forming the basic resonance defining section as a wire with the second end being connected to ground. There are a number of variations possible in relation to the reactive elements. For instance, also the first path may include a reactive element. The reactive elements of the conductive paths may also be provided through variations of the conductor structure, here through providing meandering conductive structures instead of as components. This variation would make the reactive elements be a part of first radiating element. It should here also be realized that other types of reactive elements than inductors can be used, such as capacitors. The reactive elements may furthermore have different values than the ones described. The orientation of the switching element and conductive path combination may be the opposite to the one described and thus the first switching element may be provided closer to the basic resonance defining section than the parallel conductive paths while the branch point is provided closer to the feed point than the first switching element. The matching element L1 may also be provided as a piece of conductor, like a line length, stretching out from the length varying section and more particularly out from the first conductive trace and connectable to ground. It is furthermore possible that the parasitic element is removed and that other ways of providing the second set of bands are provided than using a band gap, for instance through using another basic resonance defining section joined with the first end in parallel with the previously described basic resonance defining section. This further section would then have another length than the basic resonance defining section.

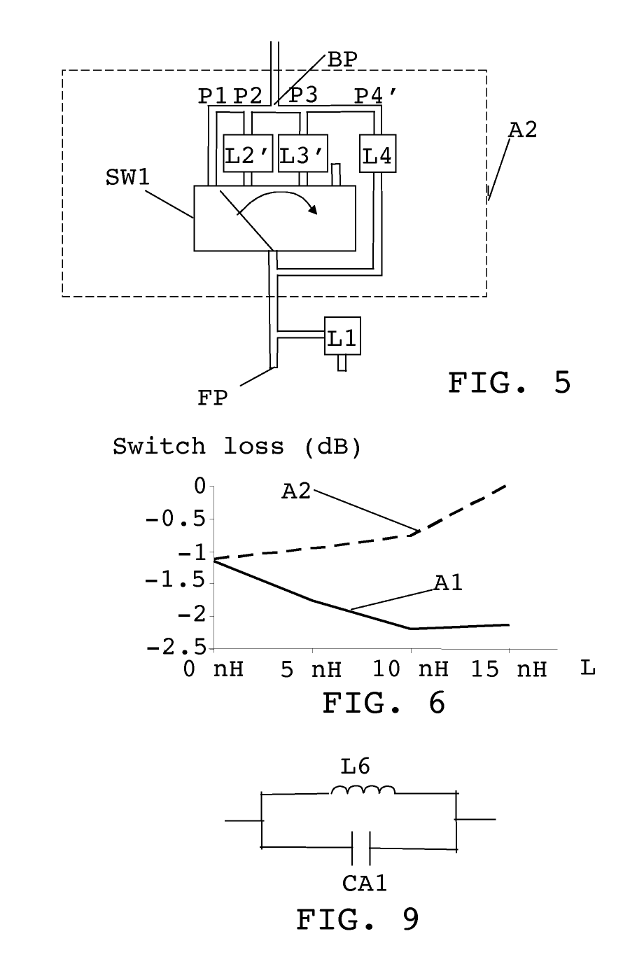

The use of the first switching element introduces switching losses. Actually, the main part of the losses in the antenna device is caused by switching losses in the first switching element. Such losses unfortunately degrade the performance of the antenna element somewhat. These losses are furthermore increased because of the tuning of the antenna device using the paths of the length varying section. In order to soften the negative impact of the switching element it is possible to connect the paths in a slightly different manner, which is schematically shown in FIG. 5, which shows a second type of switching element and conductive path combination A2.

In this second type of switching element and conductive path combination A2, the first, second and third paths P1, P2 and P3 are connected in the same way as in the first embodiment. The fourth path P4′ is however connected in a different way. Here the fourth path P4′ is provided in parallel with the switching element SW1 combined with the first, second and third paths. This means that it stretches between a first and a second position, where the first position is provided between the feed point FP and the first switching element SW1 or rather between this feed point FP and the contact area for the first switching element. The fourth path is thus connected to or joined with the first conductive trace. The second point is provided between the contact area of the first switching element SW1 and the basic resonance defining section and here this second point is connected to or joined with the branching point BP. As can be understood from FIG. 5, the fourth path P4′ is thus always directly connected between the basic resonance defining section and the feed point and thus bypassing the first switching element SW1. Another difference here is that the fourth switch position of the first switching element SW1 connects the feed point FP with a path that is broken, i.e. a path that cannot connect the feed point with the basic resonance defining section. What this does is that the first, second or third paths P1, P2, P3 are each, when selected through the first, second or third switch positions of the first switching element SW1, connected in parallel with the fourth path P4′, while the fourth path P4′ is selected through the fourth switch position of the first switching element SW1. If again the number of parallel paths is denoted n, then according to the principles of this third embodiment, n−1 paths are connected between the first switching element (or its contact area) and the first end of the basic resonance defining section. However, the n-th path stretches between the above-mentioned first and second positions. The n-th path is according to this principle also with advantage the path having the highest reactance.

In case the first path P1 is selected through the first switching element SW1 being in the first switch position, most current will run in this path P1 since it does not include any reactive element. No current will then run in the fourth path P4′. In case the second or third paths P2 or P3 are selected through the first switching element SW1 being in the second or third switch position, there will be a parallel connection of either the second or third path with the fourth path P4′ and with the current being divided accordingly between the parallel paths. In case the fourth path P4 is selected through the first switching element SW1 being in the fourth switch position, only the fourth path P4′ will conduct.

If the influences caused by the line length and the switch component phase delay are negligent, which is normally the case, this means that if the same change of resonance frequency is desired as in the first embodiment, then the fourth path should, as a rule of thumb, have the same reactance, while the third path should have a reactance that is adjusted so that the parallel connection of the reactance of the fourth and the third paths, as a rule of thumb, equals the reactance of the third path of the first embodiment. The same is then applied for the second path.

This means that a general relationship can be expressed as L3′=(L4*L3)/(L4+L3), where L3′ is the desired reactance of the third path P3. It is in the same manner possible to obtain L2′, the desired reactance of the second path P2, through substituting L2 for L3 in the equation above.

This further means that an improvement in radiation efficiency is achieved. This improvement occurs because the switch loss is also coupled in parallel. Since less current is running through the first switching element, losses are thus reduced.

The improvement in radiation efficiency in an antenna device according to a second embodiment having the second switching element and conductive path combination as compared with the antenna device of the first embodiment having the first type of switching element and conductive path combination is schematically shown in FIG. 6, which shows switch loss in dB in dependence of reactance expressed in nH. This switch loss has been determined for paths having reactances ranging from 0 to 15 nH. As can be seen the second embodiment has better efficiency, which is a significantly improved for values around 15 nH. The reason for the improvement is that some of the current is passing the fourth path also for the second and third switch positions, and since there is no switching element in this fourth path the total loss is reduced. In the fourth switch position most of the current passes the fourth path and thus there are no or very small losses because of the switching element.

Also here the orientation of the second type of switching element and conductive path combination may be varied so that it is the opposite of the one described.

The first and the second embodiments have a further advantage in that the second set of bands mentioned above can in many cases be covered without switching. This second set can thus be covered by one switch state, which in many instances is the state where the first conductive path interconnects the feed point with the basic resonance defining section of the first radiating element. It should here be realized that which switch state or path that is preferred often depends on which band gap resonance is closest to the resonance for which the parasitic element is designed to enhance.

However, there are in some instances of importance to increase this single switch state coverage. An antenna that is to cover LTE, GSM and UMTS bands will have problems with the UMTS X band that ranges between 1710 MHz and 2170 MHz using a single switch state. This means that an antenna set to cover a number of frequency bands in the first set using a first switching element will have difficulties covering one wide frequency band in the second set of frequency bands without switching.

Now a third embodiment will be described that addresses this problem, i.e., that covers this wide band in the second set of frequency bands using a single switch state in this second set of frequency bands.

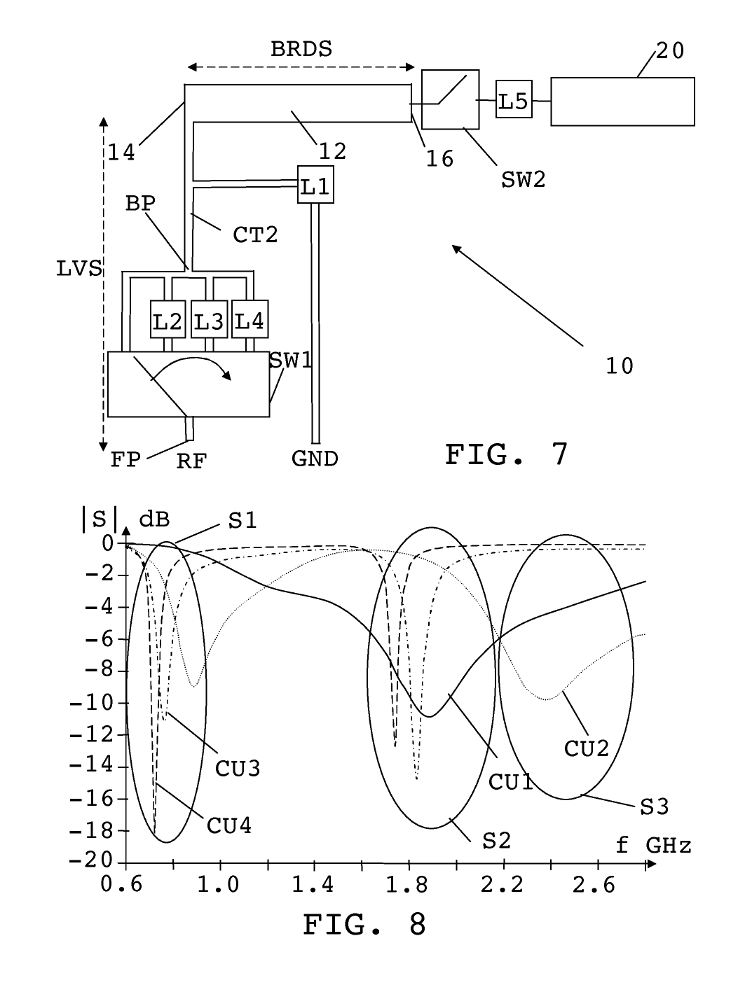

An antenna device according to this third embodiment is shown in FIG. 7. This antenna device is in many respects provided in the same way as the antenna device according to the first embodiment. It does include a first radiating element 12 having a length varying section LVS that includes a switching element and conductive path combination of the first type interconnecting a feed point FP with a basic resonance defining section BRDS. However there is no parasitic element here. The basic resonance defining section BRDS does furthermore have a different structure. It is in this embodiment not designed for providing resonance in the second set of frequency bands using a gap between two parts of the basic resonance defining section BRDS. Instead the basic resonance defining section BRDS is here provided as a patch, typically rectangular, that is designed to provide resonance in the second set of frequency bands. This means that the length of this section BRDS is selected to provide a quarter wave resonance in the second set. The patch BRDS is here furthermore at the second end 16 connected to a second radiating element 20. The second element 20 is also provided as a rectangular patch, here with essentially the same width as the basic resonance defining section BRDS of the first radiating element 12. The second element 20 is here aligned and provided in series with the basic resonance defining section BRDS of first element, so that they together form a rectangular section, when being connected, with a length that provides a combined length providing resonance in the first set of frequency bands, i.e. they together have a length selected to provide a quarter wave resonance when combined with the length varying section LVS. Thus, this means that the first and second radiating elements 12 and 20 are jointly dimensioned for providing resonance in one of the sets of frequency bands while the first radiating element is singly dimensioned for providing resonance in another set of frequency bands.

The two radiating elements 12 and 20 are furthermore connected to each other via a selective connection element. Thus, this means that the second radiating element 20 is to be connected in series with the second end 16 of the basic resonance defining section BRDS via the selective connection element. The distance between the radiating elements furthermore has to be very short. The selective connection element is in this embodiment a first type of selective connection element, which is here a second switching element SW2, which may be a single pole, single throw switch. This element is here set to disconnect the two elements 12 and 20 from each other at the second set of frequency bands, but to keep them joined at the first and third set of frequency bands.

It is possible to provide the second switching element as a PIN diode, the switching of which can be provided through providing a voltage drop across the PIN diode. A high voltage across the diode makes a DC current flow through the diode making it conductive, effectively making it conductive with respect to RF signals. With a “low” voltage across the diode, there is an insufficient voltage drop to make it conductive, i.e., it is “open”.

The second switching element SW2 is in this embodiment further connected to the second radiating element 20 via a tuning element that is here a further inductive element L5, which may be provided through a lumped component or through variations in the shape of the second radiating element, for instance through a meandering structure. This further inductor L5 has the effect of tuning the frequency bands in the third set to desired frequencies.

Although it is not clearly disclosed in FIG. 7, the switching element and conductive path arrangement may here be provided in the plane of the PCB while the first and second radiating elements may be provided on the antenna carrier in a plane perpendicular to the plane of the PCB and spaced above it. The first conductive trace may thus here be provided in the plane of the PCB, while the second conductive trace CT2 may lead from the PCB to the plane where the basic resonance defining section BRDS of the first radiating element 12 and the second radiating element 20 are provided. The second conductive trace CT2 need here not be straight but may instead take one or more turns.

Finally the matching inductor L1 is here connected to the first radiating element between the first switching element SW1 and the basic resonance defining section BRDS. It is here furthermore joined with the second conductive trace CT2 between the branching point BP where all the paths P1, P2, P3 and P4 of the set of paths meet and the first end 14 of the basic resonance defining section BRDS. The connection and matching element L1 may here be provided as a piece of conductor, like a line length, stretching out from the length varying section and more particularly from the second conductive trace CT2 and connectable to ground.

Examples on values of the inductances are here L1=25 nh, L2=4.5 nH, L3=20 nH, L4=36 nH and L6=5 nH.

In operation the first switching element SW1 is operated for varying the electrical length of the combined first and second radiating elements in the first set of frequency bands while the second switching element is closed. When operating in the second set of frequency bands the first switching element SW1 is set for interconnecting the first conducting path with the basic resonance defining section BRDS while the second switching element is kept open. In the third set of frequency bands the second switching element SW2 is again closed, while the first switching element may be operated for varying the electrical length.

FIG. 8 shows a return loss diagram for the antenna device according to the third embodiment in dependence of frequency, where the return loss 151 is expressed in dB and the frequency in GHz. Curves CU1, CU2, CU3 and CU4 are here shown that are associated with the same first switching element switch positions as in FIG. 4. Here the second, third and fourth switch positions of the first switching element are always combined with a closed second switching element, while the first switch position is always combined with an open second switch position. The first switch position may here be used for covering frequencies in the 1.9 GHz range and then between 1700 and 2200 MHz, the second switch position may cover frequencies in the 900 MHz range and then between 820 and 960 MHz at fundamental resonance and in the 2.6 GHz range and then between 2200 and 2700 MHz at harmonics resonance, the third switch position may cover frequencies generally between 750 and 800 MHz and more particularly between 740 and 810 MHz and the fourth switch position may cover frequencies generally between 700 and 750 MHz and then more particularly between 689 and 740 MHz. From FIG. 8 it can be seen that good coverage of the first set of frequency bands is obtained together with a good coverage of one frequency band in the second set using only one switch position of the first switching element. The first switch position of the first switching element SW1 together with an open second switching element therefore provides a wide band that covers the whole UMTS X band. This is furthermore combined with good properties also for the third set of frequency bands. The antenna device according to this third embodiment may cover a great number of frequency bands including LTE, UMTS I-UMTS XIV, GSM bands ranging from 710 MHz-960 MHz as well as the DCS and PCS bands. It can also be used for covering LTE bands, Bluetooth bands and WLAN bands.

There are a number of variations that can be made to the antenna device of the third embodiment. The selective element need not be a switching element. It can also be provided as a second type of selective element, which is here in the form of a filter, for instance a band blocking filter that blocks signals in the second set of frequency bands. Such an element is schematically shown in FIG. 9 where the filter is provided as a capacitor CA1 in parallel with an inductor L6. In case the third set of frequency bands are not of interest, this filter may be replaced by a low pass filter.

There are a number of other variations that can be made to this third embodiment. The length varying section can be varied in the same was as the in the first and second embodiments. Also here the matching and reactive elements may therefore be provided as variations of the conductor structure, such as meandering shaped conductors, or as components attached to corresponding contact areas. It is also possible to have the second type of switching element and conductive path arrangement. It is also possible to include a parasitic element as well as provide the connection to the matching element via the first conductive trace. The tuning element may be omitted.

Preferred embodiments of an antenna device according to the present disclosure have been described. However, it will be appreciated that these can be varied within the scope of the appended claims. The antenna device may be provided as a monopole structure like an IFA structure a patch structure like a PIFA based structure or as a loop antenna with the end opposite to the feeding end being connected to ground. Therefore the present invention is only to be limited by the following claims.

Numerical dimensions and specific materials disclosed herein are provided for illustrative purposes only. The particular dimensions and specific materials disclosed herein are not intended to limit the scope of the present disclosure, as other embodiments may be sized differently, shaped differently, and/or be formed from different materials and/or processes depending, for example, on the particular application and intended end use.

Certain terminology is used herein for purposes of reference only, and thus is not intended to be limiting. For example, terms such as “upper”, “lower”, “above”, “below”, “upward”, “downward”, “forward”, and “rearward” refer to directions in the drawings to which reference is made. Terms such as “front”, “back”, “rear”, “bottom” and “side”, describe the orientation of portions of the component within a consistent, but arbitrary, frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

Disclosure of values and ranges of values for specific parameters (such frequency ranges, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. An antenna device for a portable radio communication device operable in at least a first and a second set of frequency bands, where the first set includes at least two frequency bands and the second set includes at least one frequency band, the antenna device comprising:
a set of sections of electrically conductive material joined to each other for forming a first electrically conductive radiating element; including
a basic resonance defining section having a first and a second end and an electrical length selected to contribute to the total electrical length of the first electrically conductive radiating element for obtaining resonance at least in the first set of frequency bands;
a length varying section connected between a feed point of the first electrically conductive radiating element and the first end of the basic resonance defining section and including
a set of parallel conductive paths between the feed point and the basic resonance defining section and including at least a first and a second conductive path, where each path is arranged to influence the resonance of the electrically conductive radiating element in a separate way,
a contact area for a first switching element enabling the switching element to connect the antenna feed point to said conductive paths in order to selectively supply radio signals between the feed point and the basic resonance defining section via one of the paths in the set of conductive paths, and
at least one conductive path of the set is arranged to include a reactive element for adjusting the resonance of the first radiating element.

2. The antenna device according to claim 1, wherein there are n parallel paths in the set and n−1 paths are connected between said contact area for the first switching element and the first end of the basic resonance defining section.

3. The antenna device according to claim 2, wherein also the n^{th} path is connected between said contact area for the first switching element and the first end of the basic resonance defining section

4. The antenna device according to claim 2, wherein the n^{th} path in the set stretches between a first and a second position, where the first position is provided between said contact area for the first switching element and the feed point and the second position is provided between said contact area for the first switching element and the basic resonance defining section.

5. The antenna device according to claim 4, wherein the n^{th} path is a path arranged to include a reactive element providing the highest reactance in the set.

6. The antenna device according to claim 1, further comprising a connection to an antenna matching component via the length varying section.

7. The antenna device according to claim 6, wherein the connection to the antenna matching component is provided between the antenna feed point and said contact area for the first switching element.

8. The antenna device according to claim 6, wherein the connection to the antenna matching component is provided between a branching point where all the paths of the set meet and the first end of the basic resonance defining section.

9. The antenna device according to claim 1, further comprising a second radiating element to be connected in series with the second end of the basic resonance defining section of the first radiating element via a selective connection element where the electrical lengths of the first and second radiating elements are jointly dimensioned for providing resonance in said first set of frequency bands and the first radiating element is singly dimensioned for providing resonance in the second set of frequency bands.

10. The antenna device according to claim 9, wherein the selective connection element is a second switching element.

11. The antenna device according to claim 9, wherein the selective connection element is a filter set to block signals with frequencies above the frequencies in the first set of frequency bands.

12. The antenna device according to claim 11, wherein the filter is a band blocking filter also set to block signals with frequencies below the frequencies in a third set of frequency bands, which frequencies in the third set are higher than the frequencies in the second set of frequency bands.

13. The antenna device according to claim 9, further comprising a tuning element between the selective connection element and the second radiating element.

14. The antenna device according to claim 1, wherein said basic resonance defining section of the electrically conductive first radiating element comprises a first elongated part having said first end and a second elongated part having said second end, said second part being connected in series with the first part and stretching at least partly in parallel with the first part thereby forming a gap between the first and second parts, the dimensions of which are selected to provide resonance of the electrically conductive radiating element at least in a frequency band that differs from bands for which the electrical length of the first element is dimensioned.

15. The antenna device according to claim 1, further comprising a conductive parasitic element provided adjacent the first radiating element.

16. The antenna device according to claim 1, further comprising the first switching element.

17. The antenna device according to claim 1, further comprising the reactive elements of the set of conductive paths.

18. A portable radio communication device comprising an antenna device operable in at least a first and a second set of frequency bands, where the first set includes at least two frequency bands and the second set includes at least one frequency band, the antenna device comprising:
a set of sections of electrically conductive material joined to each other for forming a first electrically conductive radiating element; including:
a basic resonance defining section having a first and a second end and an electrical length selected to contribute to the total electrical length of the first electrically conductive radiating element for obtaining resonance at least in the first set of frequency bands;
a length varying section connected between a feed point and the first end of the basic resonance defining section and including
a set of parallel conductive paths between the feed point and the basic resonance defining section including at least a first and a second conductive path, where each path is arranged to influence the resonance of the electrically conductive radiating element in a separate way,
a first switching element connecting the antenna feed point to conductive paths of the set of paths in order to selectively supply radio signals between the basic resonance defining section and the feed point via one of the paths in the set of paths, and
a reactive element in at least one conductive path of the set of paths for adjusting the resonance of the first radiating element.
